(19) United States
(12) Patent Application Publication
(10) Pub. No.: US 2006/0209396 A1
(43) Pub. Date: Sep. 21, 2006

(54) Monitoring device

(75) Inventors: Hirokazu Tanaka, Kyoto-fu (JP); Tetsuya Onishi, Kyoto (JP); Ryuji Kawamoto, Kyoto (JP)

Correspondence Address: OSHA LIANG L.L.P., 1221 MCKINNEY STREET, SUITE 2800, HOUSTON, TX, 77010, US

(73) Assignee: OMRON CORPORATION, Kyoto (JP)

(21) Appl. No.: 10/564,793

(22) PCT Filed: Jul. 12, 2004
(86) PCT No.: PCT/JP04/09933

§ 371 Date: Jan. 13, 2006

(30) Foreign Application Priority Data
Jul. 14, 2003 (JP) 2003-274105

(51) Int. Cl. H01S 3/00

(52) U.S. Cl. 359/347

(57) ABSTRACT

[Object] A monitoring device for precisely taking out light for a monitor and having a simple structure and able to be made compact is provided.

[Means for Resolution] A lens array 17 is attached to the tip face of an optical fiber array 12 holding optical fibers 14, 15 in parallel. A lens 19 is arranged in the lens array 17 so as to be opposed to the end face of each of the optical fibers 14, 15. A triangular prism 13 is arranged in front of the lens array 17. An incident-emitting face 22 of the triangular prism 13 is inclined with respect to the lens array 17. Signal light L emitted from the optical fiber 14 is converted into parallel light by the lens 19, and is incident to the triangular prism 13. After the signal light L is then totally reflected on the reflecting face 20, the signal light L is incident to a reflecting face 21. The incident angle of the signal light L incident to the reflecting face 21 is slightly smaller than a critical angle of the total reflection. The signal light L is leaked from the reflecting face 21 to the exterior by a constant ratio κ. Accordingly, the amount of the signal light L can be calculated by measuring this leak light La.

### TECHNICAL FIELD

The present invention relates to a monitoring device for detecting a light amount in the field of optical communication.

### BACKGROUND ART

FIG. 1 is a schematic view for explaining a light amount monitoring method used in a light transmitter of a conventional example (patent literature 1). In this conventional example, a laser beam 2 emitted from a semiconductor laser 1 is incident to a light transmitting path 3 approximately bent in an S-character shape from its end face. Leak light of a constant ratio (e.g., several %) radiated from a bent portion 3a of the light transmitting path 3 is received by a light receiving element 4. The light amount emitted from the semiconductor laser 1 or a propagating light amount in the light transmitting path 3 is calculated on the basis of the received light amount in the light receiving element 4.

In such a conventional system, the leak light can be monitored by a simple construction. However, it was difficult to control the leak light amount radiated from the bent portion 3a of the light transmitting path 3 and its leak direction so that measurement accuracy was low. Further, when the curvature of the bent portion 3a was increased, the leak light amount in the bent portion 3a was increased. Accordingly, no curvature of the bent portion 3a could be increased so much so that it was difficult to make the device compact. Further, it was impossible to structurally cope with the formation of multi-channels.

FIG. 2 is a schematic view showing another conventional example (patent literature 2). In this conventional example, two optical fibers 5, 6 are arranged in parallel, and end faces of both the optical fibers 5, 6 are mutually inclined toward the opposite side. A meniscus lens 7 is arranged in a position opposed to the end faces of these optical fibers 5, 6 such that a concave face is directed to the optical fibers 5, 6 sides. A branch filter 8 for transmitting partial (e.g., several %) light and reflecting a large portion of light is arranged on the concave face of the meniscus lens 7. Further, an optical fiber 9 for a monitor is arranged on the convex face side of the meniscus lens 7.

Signal light L emitted from the core of the optical fiber 5 is refracted by the inclination of its end face, and is emitted slantingly rightward and upward, and is incident to the meniscus lens 7. A large portion of the signal light L incident to the meniscus lens 7 is reflected by the branch filter 8 slantingly leftward and upward, and is incident to the core of the optical fiber 6. Namely, a large portion of light propagated in the optical fiber 5 is coupled to the optical fiber 6 through the meniscus lens 7.

On the other hand, one portion (e.g., several %) of the signal light L emitted toward the meniscus lens 7 from the optical fiber 5 is transmitted through the branch filter 8 and is converged by the meniscus lens 7, and is incident to the core of a backward optical fiber 9 for a monitor. Accordingly, the amount of the signal light L propagated in the optical fiber 5 or the optical fiber 6 can be calculated by measuring the amount of light incident to this optical fiber 9.

However, in the conventional system as shown in FIG. 2, it is necessary to perform complicated slanting polishing on the end faces of the optical fibers 5, 6. Further, the meniscus lens 7 forming the branch filter 8 on the concave face side, etc. are required. Accordingly, productivity was bad and cost was high. Further, a large spatial distance is required between the optical fibers 5, 6 and the optical fiber 9. Further, it is necessary to arrange a light receiving element at the other end of the optical fiber 9. Therefore, it was difficult to make the device compact. Further, it was difficult to structurally cope with the formation of multi-channels.

Patent literature 1: JP-A-2000-171662

Patent literature 2: JP-A-10-170750

### DISCLOSURE OF THE INVENTION

The present invention is made in consideration of the above technical problems, and its object is to provide a monitoring device able to precisely take out light for a monitor, and be structurally simplified and be made compact.

The monitoring device in the present invention is characterized in a monitoring device for detecting the amount of signal light propagated in a light transmitting path, and comprises:

the light transmitting paths in which at least end portions are held approximately in parallel and two light transmitting paths are set to one set; and

a prism having two interfaces perpendicular to each other, and returning the incident signal light toward an original incident direction by twice reflecting the signal light at the two interfaces;

wherein the signal light emitted from the end face of one light transmitting path among the one set of optical transmitting paths is incident into the prism; the signal light is returned to the original incident direction by twice reflecting the signal light at the two interfaces of the prism; the signal light is incident to the end face of the other light transmitting path among the one set of light transmitting paths; and the signal light of a predetermined ratio is leaked from at least one of the two interfaces of the prism. Here, an optical fiber, an optical waveguide, etc. are included in the light transmitting path.

In accordance with the monitoring device of the present invention, only the signal light of a predetermined ratio can be leaked out of the prism. Accordingly, if the amount of the light leaked out of the prism is measured, the original amount of the signal light can be known from the predetermined ratio and the measured light amount. Furthermore, since this monitoring device has a simple construction formed by an optical waveguide and the prism, this monitoring device can be cheaply manufactured by using a prism sold at a market, etc. Further, since the monitoring device has the simple construction, the monitoring device can be easily assembled and can be made compact.

In an embodiment mode of the present invention, it is characterized in that a light receiving means for receiving the signal light leaked from the interface is arranged. A light receiving element such as a photodiode, etc., a light receiving element array, etc. are included in the above light receiving means. In the embodiment mode having the light receiving means, it is desirable that this light receiving means is positioned with the leaking-out interface of the signal light in the prism as a reference.

The light receiving means for measuring the amount of the signal light leaked from the prism in this embodiment mode may be also arranged in the exterior of the monitoring device. However, the light amount measurement accuracy of the leaked signal light can be raised by integrating the light receiving means with the monitoring device, and the monitoring device can be made compacter. Further, if the light receiving means is positioned with the leaking-out interface of the signal light in the prism as a reference, the measurement accuracy of the light amount using the light receiving means can be stabilized and improved.

In another embodiment mode of the present invention, it is characterized in that, when it is seen from a direction perpendicular to a plane orthogonal with respect to the mutually orthogonal two interfaces of the prism, a line segment for dividing a narrow angle of the orthogonal two interfaces into two equal parts is inclined from a direction parallel with an optical axis direction of the end portion of the light transmitting path.

In this embodiment mode, as a method for leaking-out one portion of the signal light from the prism, the line segment for dividing the narrow angle of the above orthogonal two interfaces into two equal parts is inclined from the direction parallel with the optical axis direction of the end portion of the above light transmitting path when it is seen from the direction perpendicular to the plane orthogonal with respect to the mutually orthogonal two interfaces of the prism. Therefore, the signal light is incident at an incident angle smaller than a critical angle of the total reflection at one interface. Accordingly, one portion of the signal light is leaked from this interface. Accordingly, in accordance with this embodiment mode, the ratio of the leak amount can be easily adjusted by merely adjusting the angle of the prism.

In still another embodiment mode of the present invention, it is characterized in that a filter for leaking-out one portion of the incident light to the exterior of a light transmitting property medium is formed at least one interface among the two interfaces of the prism.

In this embodiment mode, a filter for leaking-out one portion of the incident light to the exterior of a light transmitting property medium is formed at at least one of the two interfaces of the prism as a separate method for leaking-out one portion of the signal light from the prism. Accordingly, it is not necessary to adjust the leak amount by the angular adjustment of the prism and no assembly adjustment is required.

In still another embodiment mode of the present invention, it is characterized in that a deflecting means for changing an emitting direction of the signal light leaked from the interface of the prism is arranged.

Further, in the embodiment mode for arranging the deflecting means for changing the emitting direction of the signal light leaked from the interface of the prism, the restriction of an arranging position of the light receiving means can be reduced and the degree of freedom of design is improved.

In still another embodiment mode of the present invention, it is characterized in that plural sets of light transmitting paths are arranged with two light transmitting paths as one set, and these light transmitting paths are arranged in a line in parallel with a plane orthogonal with respect to the mutually orthogonal two interfaces of the prism.

In still another embodiment mode of the present invention, it is characterized in that plural sets of light transmitting paths are arranged with two light transmitting paths as one set, and the two light transmitting paths as one set are respectively arranged in parallel with a plane orthogonal with respect to the mutually orthogonal two interfaces of the prism.

When plural sets of light transmitting paths with two light transmitting paths as one set are arranged as in the above two embodiment modes, these light transmitting paths may be also arranged in a line in parallel with the plane orthogonal with respect to the mutually orthogonal two interfaces of the above prism. The two light transmitting paths constituting one set may be also respectively arranged in parallel with the plane orthogonal with respect to the mutually orthogonal two interfaces of the above prism. In accordance with these constructions, the amount of the signal light propagated in the plural sets of light transmitting paths can be monitored at one time.

The constructional elements of this invention explained above can be arbitrarily combined as much as possible.

### BRIEF DESCRIPTION OF THE DRAWINGS

FIG. 1 is a schematic view for explaining a monitoring method of a light amount in a conventional example.

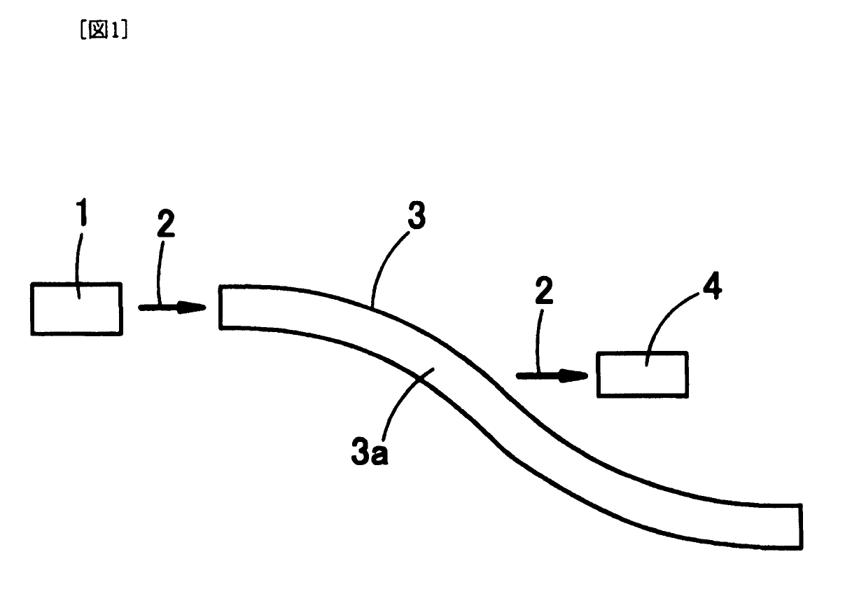

FIG. 2 is a schematic view for explaining a monitoring method of a light amount in another conventional example.

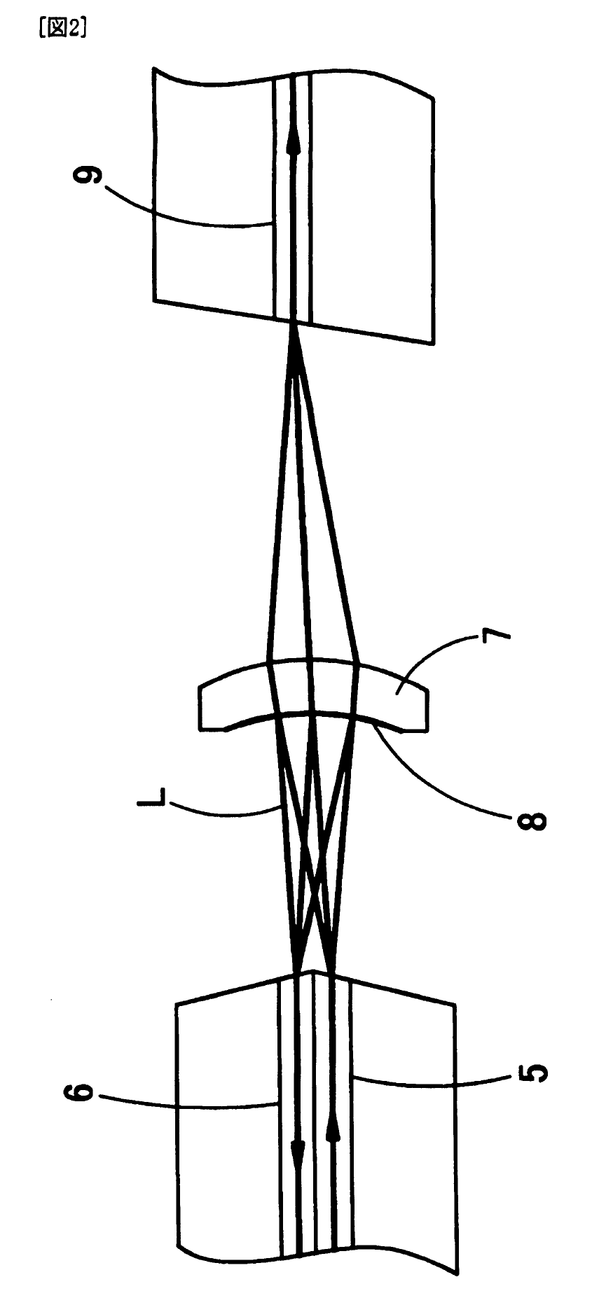

FIG. 3 is a schematic perspective view of a monitoring device in an embodiment 1 of the present invention.

FIG. 4 is a side view of this monitoring device.

FIG. 5 is a cross-sectional view for explaining the operation of this monitoring device.

FIG. 6(a) is a view for explaining the operation of a lens, and FIG. 6(b) is a view for explaining the operation of a different lens.

FIGS. 7(a), 7(b) and 7(c) are schematic sectional views for explaining an adjusting method of the monitoring device of FIG. 3.

FIG. 8 is a cross-sectional view for explaining a different adjusting state of the monitoring device of FIG. 3.

FIG. 9 is a schematic perspective view of a monitoring device in an embodiment 2 of the present invention.

FIG. 10(a) is a schematic sectional view showing a state before an adjustment of this monitoring device, and FIG. 10(b) is a schematic sectional view showing a state after the adjustment.

FIG. 11 is a perspective view of a monitoring device in an embodiment 3 of the present invention.

FIG. 12 is a plan view of this monitoring device.

FIG. 13 is a perspective view of a monitoring device in an embodiment 4 of the present invention.

FIG. 14 is a cross-sectional view for explaining the operation of this monitoring device.

FIG. 15 is a schematic sectional view of a triangular prism and a deflecting prism in the monitoring device of FIG. 13.

FIG. 16 is a perspective view of a monitoring device in an embodiment 5 of the present invention.

FIG. 17(a) is a cross-sectional view in the position of an optical fiber at the upper stage of this monitoring device, and FIG. 17(b) is a cross-sectional view in the position of the optical fiber at the lower stage of this monitoring device.

FIG. 18(a) is a cross-sectional view showing a state before an adjustment of the monitoring device of FIG. 16, and FIG. 18(b) is a cross-sectional view showing a state after the adjustment.

FIG. 19 is a perspective view of a monitoring device in an embodiment 6 of the present invention.

FIG. 20 is an enlarged sectional view of this monitoring device.

FIG. 21 is a perspective view of a monitoring device in an embodiment 7 of the present invention.

FIG. 22 is an enlarged sectional view of this monitoring device.

FIG. 23 is a perspective view of a monitoring device in an embodiment 8 of the present invention.

FIG. 24 is a cross-sectional view of this monitoring device.

FIG. 25 is a perspective view of a monitoring device in an embodiment 9 of the present invention.

FIG. 26 is a cross-sectional view of this monitoring device.

Main reference numerals used in the drawings are follows.
12 optical fiber array
13 triangular prism
14, 15 optical fiber
14a, 14b, - - - , 15a, 15b, - - - optical fiber
17 lens array
19 lens
20, 21 reflecting face
24 light receiving element
33 light receiving element array
38 deflecting prism
45 deflecting prism
52 branch filter
54 deflecting prism
L signal light
La leak light

### BEST MODE FOR CARRYING OUT THE INVENTION

The embodiments of the present invention will next be explained in detail in accordance with the drawings. However, the present invention is not limited to the following embodiments, but can be naturally modified in the scope not departing from the technical idea of the present invention.

### Embodiment 1

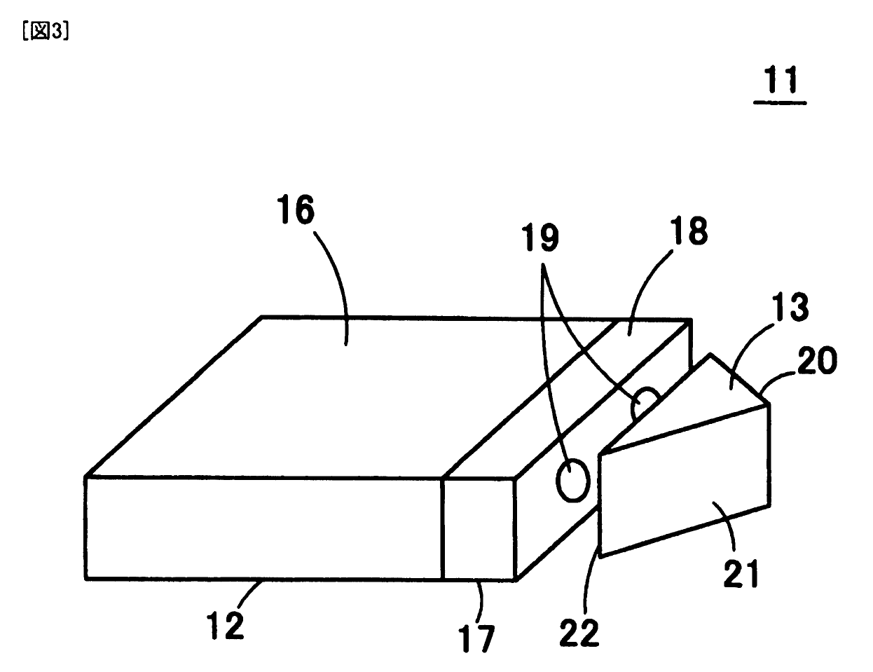

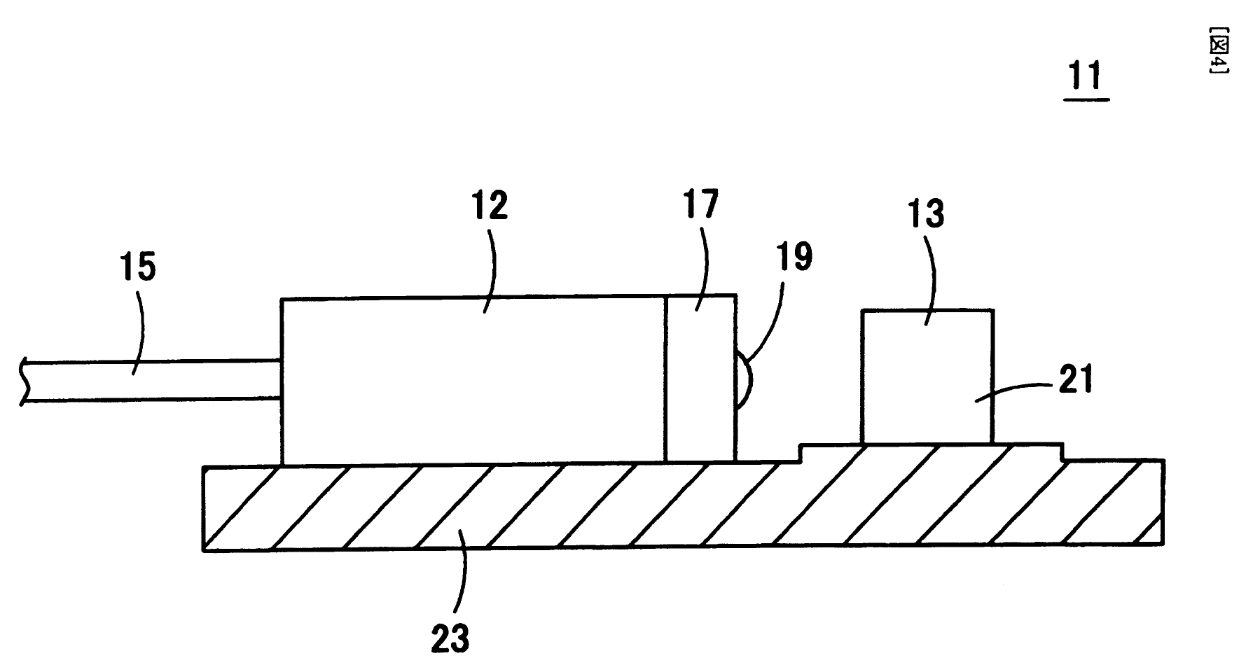

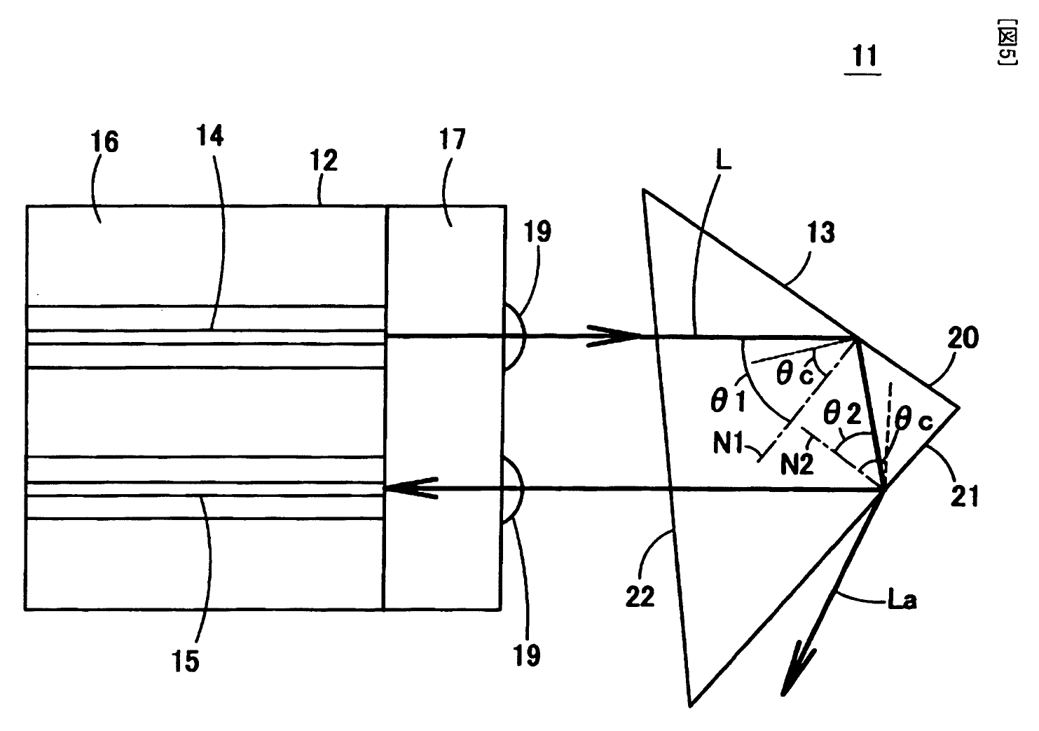

FIG. 3 is a perspective view showing the structure of a monitoring device 11 in an embodiment 1 of the present invention. FIG. 4 is a side view of this structure. FIG. 5 is a schematic sectional view for explaining the operation of this monitoring device 11 (a prism is exaggeratedly largely drawn). The monitoring device 11 is mainly constructed by an optical fiber array 12 of two cores, and a triangular prism 13. In the optical fiber array 12, two optical fibers 14, 15 are held by a holder 16 by properly arranging their end portions. In the interior of the holder 16, the two optical fibers 14, 15 are positioned at a predetermined pitch and are held in parallel. Each of these optical fibers 14, 15 constitutes an optical communication line, and an optical signal is transmitted to each of these optical fibers 14, 15. A lens array 17 is attached to the tip face of the optical fiber array 12. The lens array 17 is formed by arranging two lenses 19 constructed by a spherical lens or an aspherical lens on the surface of a substrate 18 constructed by resin or glass having a light transmitting property. The lens array 17 is adjusted so as to conform the optical axes of the cores of the optical fibers 14, 15 and the optical axis of each lens 19, and is then fixed to the tip face of the optical fiber array 12.

The triangular prism 13 is a prism having a right-angled equilateral triangle seen from a plane, and a product sold at a market and manufactured by glass, etc. can be used. The triangular prism 13 has two faces perpendicular to each other (these faces are called reflecting faces 20, 21), and a face (this face is called an incident-emitting face 22) forming an angle of 45 degrees with respect to the reflecting faces 20, 21. The triangular prism 13 is arranged in front of the optical fiber array 12 such that the incident-emitting face 22 is opposed to the lens array 17. One reflecting face 20 is located on an extension of the optical fiber 14, and the other reflecting face 21 is located on an extension of the optical fiber 15.

As shown in FIG. 4, the optical fiber array 12 is fixed onto a base 23 such as a casing, a circuit substrate, etc. of the monitoring device 11 by a means of adhesion, screw fastening, etc. before the triangular prism 13. As described later, the triangular prism 13 is fixed to the base 23 by using a fixing means of an adhesive, a screw, etc. after an angular adjustment and a position adjustment are made.

In this monitoring device 11, in a state in which the triangular prism 13 is adjusted and fixed in angle and position, the triangular prism 13 is inclined by a predetermined angle with respect to the optical fiber array 12 as shown in FIG. 5. The front face of the lens array 17 and the incident-emitting face 22 of the triangular prism 13 are set not to be parallel with each other.

When signal light L is emitted from one optical fiber 14 of the optical fiber array 12, this signal light L is collimated by the lens 19, and is next incident into the triangular prism 13 from the incident-emitting face 22. The signal light L incident into the triangular prism 13 is incident to the reflecting face 20 of the triangular prism 13 at an incident angle θ1 (an incident angle measured from a normal line N1 rising on the reflecting face 20) greater than a critical angle θc of total reflection of the triangular prism 13 interface, and is totally reflected on the reflecting face 20. The signal light totally reflected on the reflecting face 20 is incident to the other reflecting face 21. At this time, an incident angle θ2 (an incident angle measured from a normal line N2 rising on the reflecting face 21) of the light incident to the reflecting face 21 is slightly smaller than the critical angle θc of total reflection of the triangular prism 13 interface. Therefore, the signal light of a predetermined ratio κ (<<1) among the signal light incident to the reflecting face 21 is leaked from the reflecting face 21 to the exterior. The signal light L is reflected on the reflecting face 21 in the remaining ratio (1−κ), and is returned to the lens array 17 side. The signal light L returned to the lens array 17 side is converged by the lens 19, and is coupled to the core of the optical fiber 15.

Accordingly, if the amount of light leaked from the reflecting face 21 of the triangular prism 13 is measured by using a light receiving element of a photodiode, etc., it is possible to know the amount of the signal light L propagated in the optical fiber 14 or the optical fiber 15. Namely, if a result obtained by measuring the amount of light leaked from the reflecting face 21 of the triangular prism 13 by the light receiving element is set to Pmoni, the amount of the signal light L propagated within the optical fiber 14 becomes
Pmoni/κ.
Otherwise, the amount of the signal light L propagated within the optical fiber 15 becomes
(1−κ) Pmoni/κ.

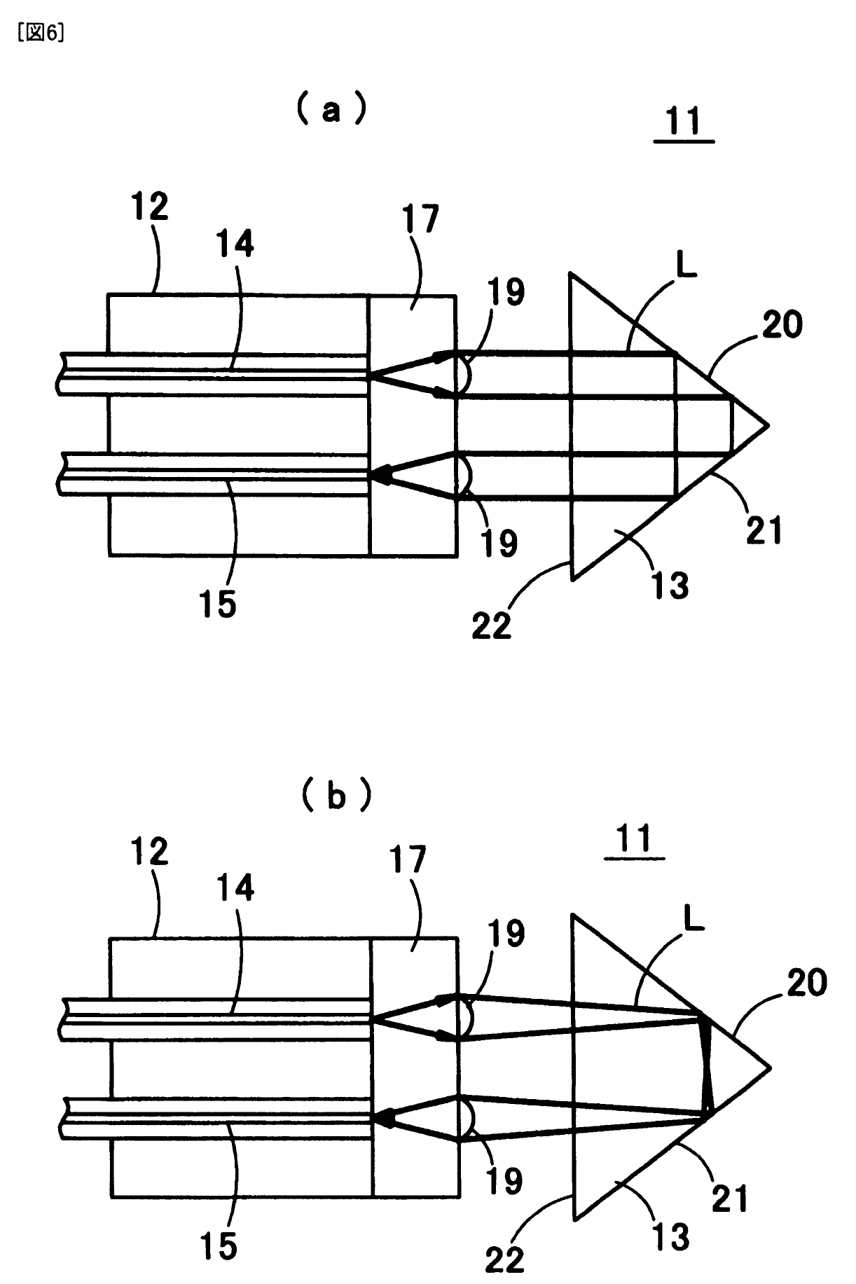

FIGS. 6(a) and 6(b) are views showing the operation of the lens 19 arranged in the lens array 17 (a prism is exaggeratedly largely drawn). In the example of FIG. 6(a), the signal light L emitted from the core of the optical fiber 14 is converted into parallel light by the lens 19, and is incident into the triangular prism 13 while this signal light L is the parallel light. This signal light L is then twice reflected on the reflecting faces 20, 21. The parallel light emitted toward the original direction from the incident-emitting face 22 is converged by the lens 19 and is coupled to the core end face of the optical fiber 15.

Further, in the example of FIG. 6(b), the signal light L emitted from the core of the optical fiber 14 is converged by the lens 19, and is incident into the triangular prism 13 while the signal light L is converged. The signal light L is then reflected on the reflecting face 20, and is converged to one point at the center of the reflecting face 20 and the reflecting face 21. Thereafter, the signal light L becomes diffusion light and is reflected on the reflecting face 21. The diffusion light emitted from the incident-emitting face 22 to the original direction is converged by the lens 19, and is coupled to the core end face of the optical fiber 15.

In the monitoring device 11 of the present invention, one of the system of FIG. 6(a) and the system of FIG. 6(b) may be used. However, it is desirable to adopt the system of FIG. 6(b) and receive light by the light receiving element at a distance at which no leak light La leaked from the reflecting face 21 is widened so much (at least while the diameter of a light beam section is smaller than the diameter of the lens).

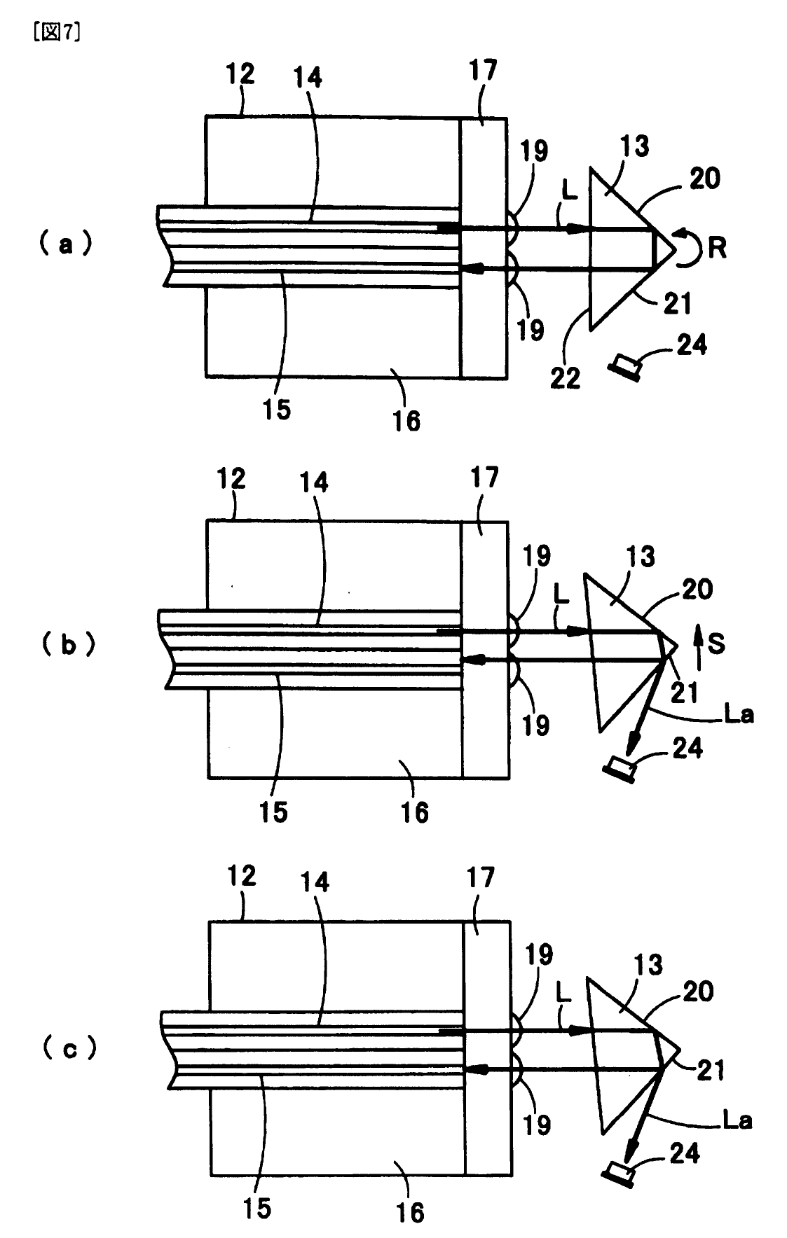

FIGS. 7(a), 7(b) and 7(c) are views for explaining an adjusting method of the triangular prism 13 in the monitoring device 11 of the present invention. First, as shown in FIG. 7(a), the triangular prism 13 is arranged in front of the optical fiber array 12, and the lens array 17 and the incident-emitting face 22 of the triangular prism 13 are set to be parallel. Further, the monitoring device 11 is arranged such that the signal light L emitted from the optical fiber 14 is twice totally reflected on the reflecting faces 20, 21 of the triangular prism 13, and is returned to the original direction, and is incident to the optical fiber 15.

Next, the signal light L of the known light amount Po is emitted from the optical fiber 14, and the triangular prism 13 is rotated in the R-direction, and one portion of the signal light L is leaked out of the reflecting face 21 of the triangular prism 13. When the triangular prism 13 is rotated in the R-direction, the incident angle of the signal light L incident to the reflecting face 20 is increased. Accordingly, after the signal light L is totally reflected on the reflecting face 20, the signal light L is incident to the reflecting face 21. When the triangular prism 13 is rotated in the R-direction, the incident angle to the reflecting face 21 is reduced. Accordingly, when this incident angle becomes the critical angle of the total reflection or less at the interface of the triangular prism 13, the incident angle to the reflecting face 21 is also gradually reduced as the inclination of the triangular prism 13 is increased. Thus, the leak of the signal light L leaked from the reflecting face 21 is increased. Therefore, as shown in FIG. 7(b), while the leak light La from the reflecting face 21 is monitored by a light receiving element 24, the light amount Pmoni of the leak light La is detected and the angle of the triangular prism 13 is finely adjusted such that the ratio κ=Pmoni/Po of the leak light La becomes a predetermined value (e.g., κ=0.01).

After the angle of the triangular prism 13 is adjusted such that the ratio κ of the leak light La becomes the predetermined value, the inclination of the triangular prism 13 is set as it is, and the triangular prism 13 is moved in parallel in the S-direction perpendicular to the optical fibers 14, 15. As shown in FIG. 7(c), the position of the triangular prism 13 is determined in a position for maximizing the amount of the signal light L incident to the optical fiber 15. After the optimum position of the triangular prism 13 is thus determined, the triangular prism 13 is fixed to the base 23, etc. by an adhesive such as an ultraviolet hardening type adhesive, etc., and is also fixed by using a stopper fastener such as a crew, etc.

In each light amount monitor 11, the triangular prism 13 may be also adjusted one by one as mentioned above. However, for example, at a lot starting time, the position and angle of the triangular prism 13 may be determined by adjusting the beginning monitoring device 11 as mentioned above. With respect to the subsequent monitoring device 11, the triangular prism 13 may be also attached by an assembly machine in its position and angle without making an adjusting work one by one.

The light receiving element 24 may be also arranged in the exterior of this monitoring device 11, and may be also constructed as one portion of the monitoring device 11. When the light receiving element 24 is assembled in advance as one portion of the monitoring device 11, the light receiving element 24 is also fixed to the base 23, etc. after the position and angle able to efficiently receive the above leak light La are adjusted.

In accordance with the monitoring device 11 of the present invention, the two optical fibers 14, 15 are arranged in parallel, and it is sufficient to merely arrange the triangular prism 13 on its end face side so that the monitoring device 11 can be easily made compact. Further, the ratio of the leak light La can be precisely controlled by adjusting the rotating angle of the triangular prism 13. Further, the emitting direction of the leak light La can be also easily controlled, and the leak light La can be reliably received by the light receiving element 24.

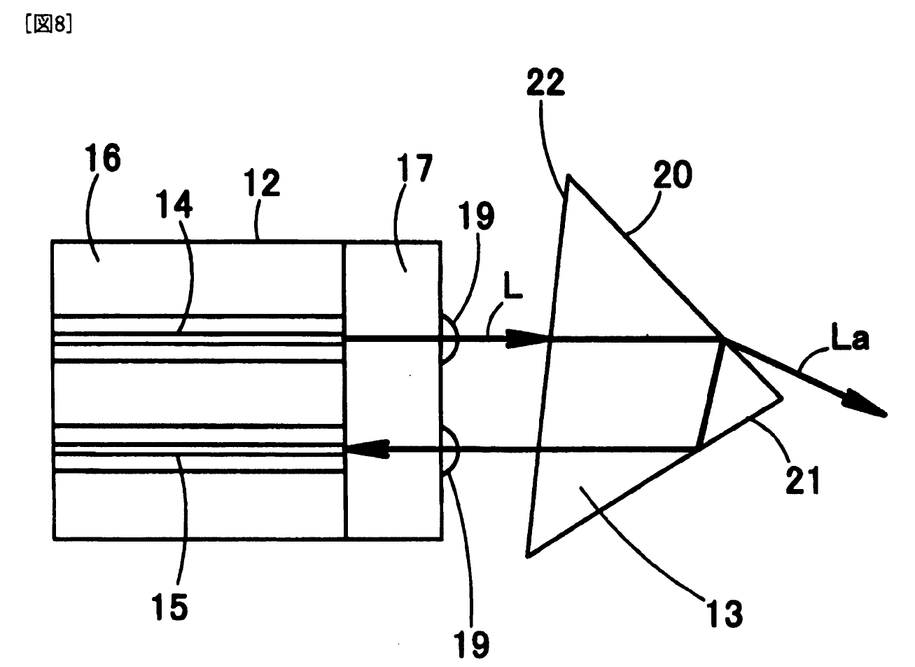

In the examples shown in FIGS. 5, 7, etc., the signal light L is totally reflected on the first reflecting face 20, and one portion of the signal light L is leaked from the reflecting face 21 on the second reflecting face 21. In contrast to this, as shown in FIG. 8 (a prism is exaggeratedly largely drawn), if the rotating angle is adjusted by setting the rotating direction of the triangular prism 13 to an opposite direction, one portion of the signal light L is leaked from the reflecting face 20 on the first reflecting face 20, and the signal light L can be set to be totally reflected on the second reflecting face 21.

### Embodiment 2

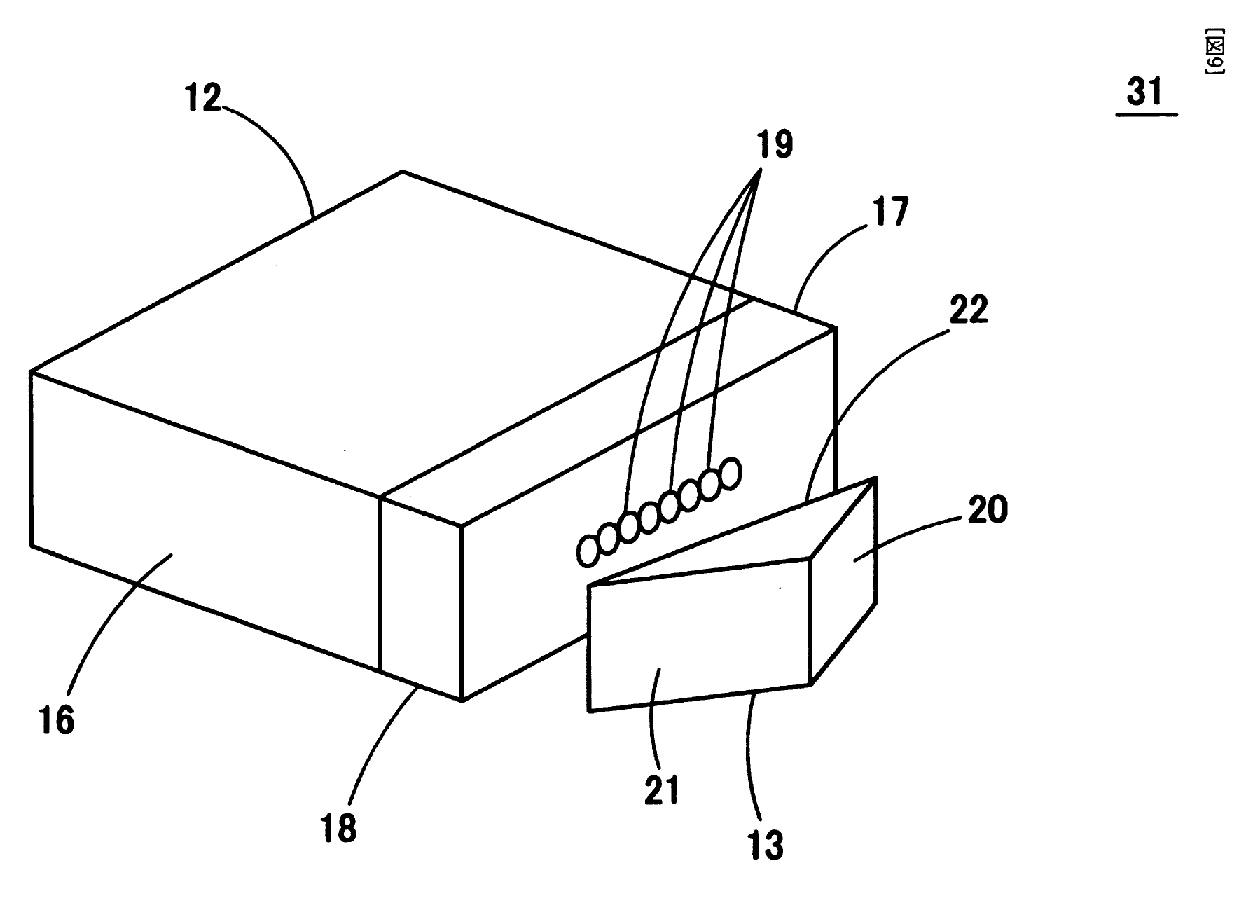

FIG. 9 is a perspective view showing the structure of a monitoring device 31 in an embodiment 2 of the present invention. An optical fiber array 12 of multiple cores is used in this monitoring device 31. For example, the end portions of many optical fibers 14a, 14b, - - - , 15b, 15a such as 8 optical fibers, 12 optical fibers, etc. are properly arranged in parallel and are held in the optical fiber array 12. Many lenses 19 such as 8 lenses, 12 lenses, etc. are also arranged in the lens array 17 correspondingly to the respective optical fibers 14a, 14b, - - - , 15b, 15a. A triangular prism of a size corresponding to each of the optical fibers 14a, 14b, - - - , 15b, 15a and the lens 19 is used in the triangular prism 13. In the following description, the number of optical fibers is set to 8.

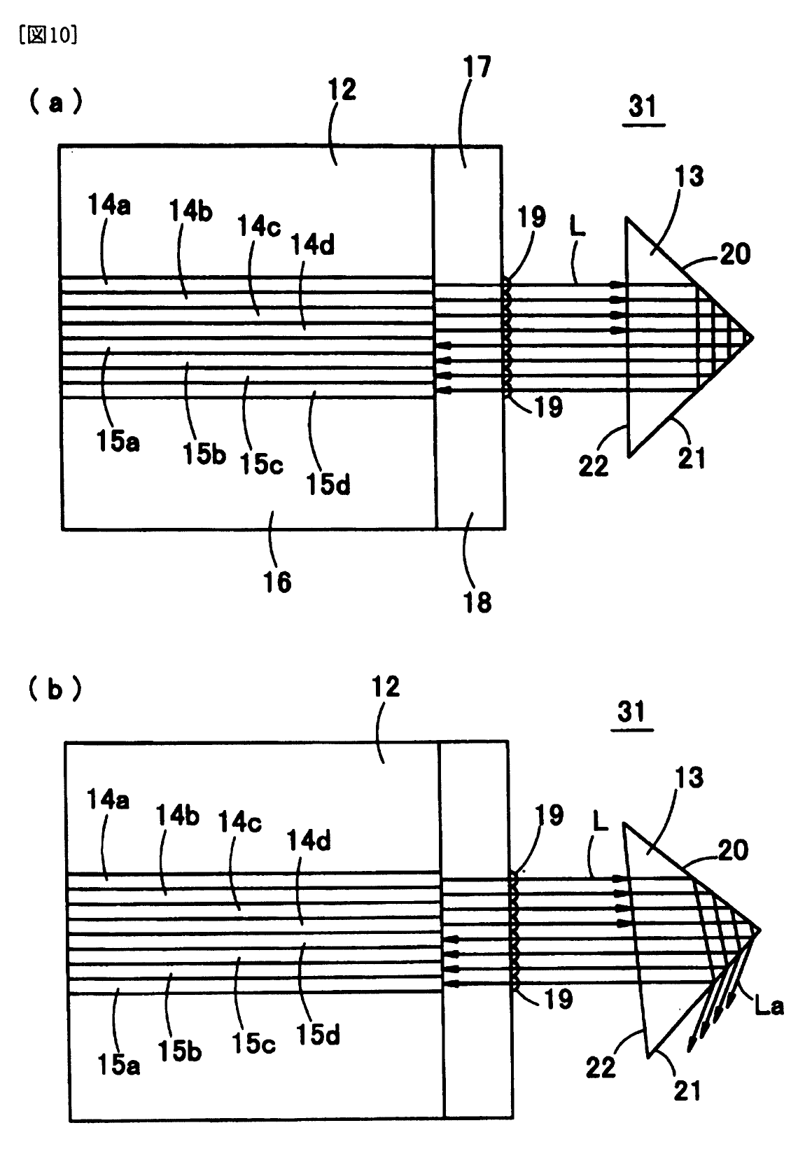

In a state before an adjustment, as shown in FIG. 10(a), signal light L emitted from the optical fiber 14a is collimated by the lens 19 and is incident into the triangular prism 13. The signal light L is then twice totally reflected on reflecting faces 20, 21 and is incident to the lens 19 from the triangular prism 13. The signal light L is then converged by the lens 19 and is coupled to the optical fiber 15a. Similarly, the signal lights L emitted from optical fibers 14b, 14c, 14d in parallel with each other respectively pass through the lens 19 and are twice totally reflected on the reflecting faces 20, 21 of the triangular prism 13, and are returned to the lens 19 and are respectively coupled to optical fibers 15b, 15c, 15d.

When the angle, etc. of the triangular prism 13 are adjusted by a start from this state before the adjustment (see FIG. 7), the signal light L emitted from each of the optical fibers 14a, 14b, 14c, 14d is incident to the reflecting face 21 at an equal incident angle as shown in FIG. 10(b). Accordingly, each signal light L is leaked out of the reflecting face 21 in an equal ratio κ. Therefore, if the amount of the leak light La from the reflecting face 21 among the signal light L emitted from each of the optical fibers 14a, 14b, 14c, 14d is individually measured by a light receiving element, the amount of each signal light L propagated within each of the optical fibers 14a, 14b, 14c, 14d can be monitored.

### Embodiment 3

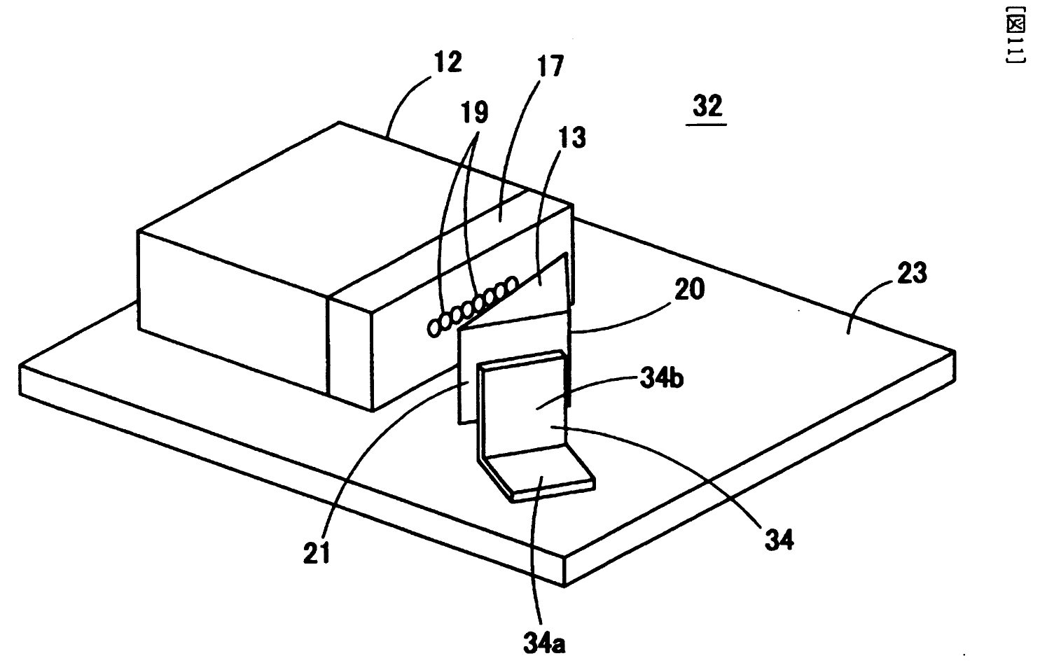

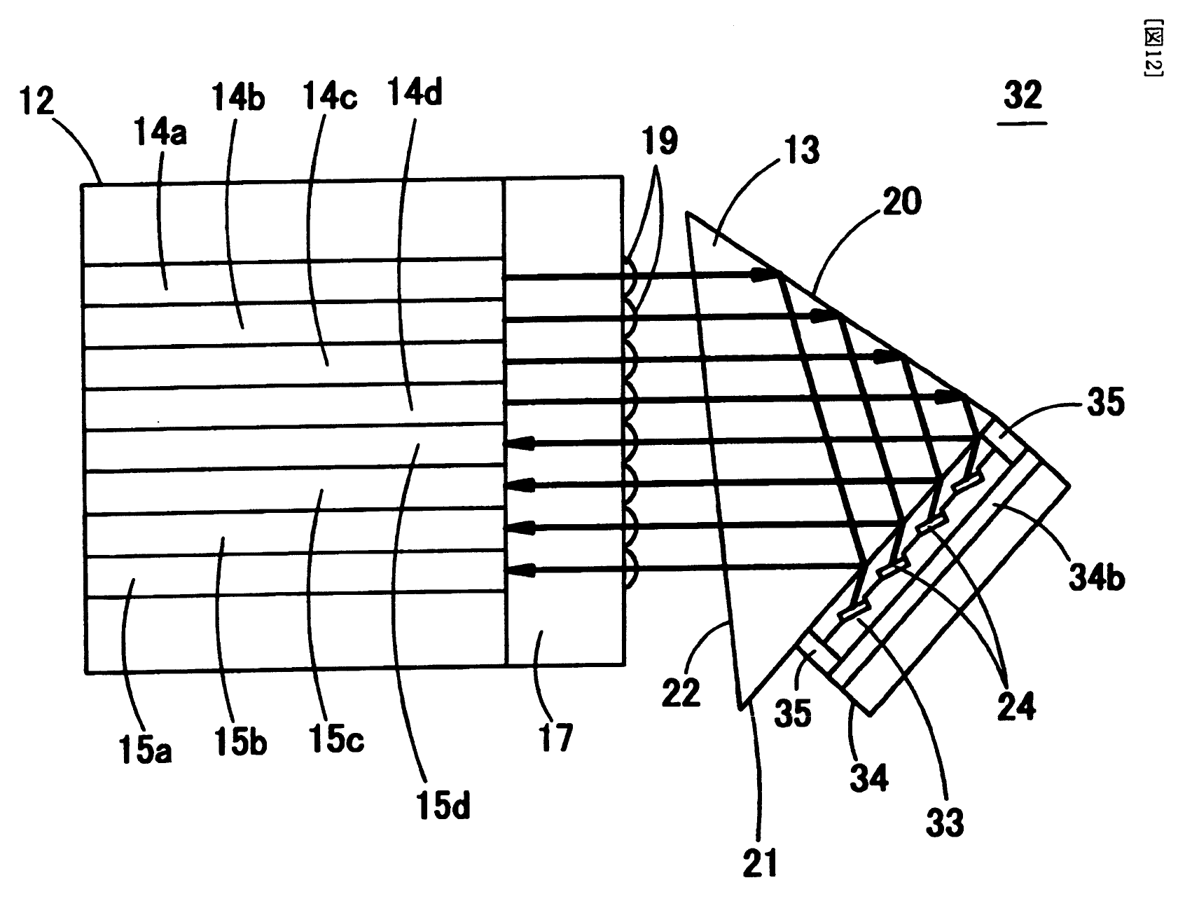

FIG. 11 is a perspective view showing the structure of a monitoring device 32 in an embodiment 3 of the present invention. FIG. 12 is a plan view of this structure. In this monitoring device 32, the monitoring device 31 of the embodiment 2 is set to a foundation, and a light receiving element array 33 is added to this monitoring device 31.

A horizontal piece 34a of a flexible substrate 34 approximately bent in an L-shape is joined onto the upper face of a base 23. The light receiving element array 33 is mounted to a longitudinal vertical piece 34b of the flexible substrate 34. Further, two spacers 35 are attached to the longitudinal vertical piece 34b so as to nip the light receiving element array 33. The flexible substrate 34 is attached to the triangular prism 13 and the upper face of the base 23 such that the spacer 35 abuts on the reflecting face 21 of the triangular prism 13 after the adjustment. The light receiving element array 33 is arranged in parallel with the reflecting face 21 so as to form a clearance between the light receiving element array 33 and the reflecting face 21. Plural light receiving elements 24 are mounted to the light receiving element array 33. Each light receiving element 24 is inclined in an incident direction of leak light La so as to efficiently receive the leak light La emitted from the reflecting face 21.

In accordance with such a monitoring device 32, the angle of the triangular prism 13, etc. are adjusted so as to leak light from the reflecting face 21 in a predetermined ratio κ. Thereafter, the monitoring device 32 can be simply assembled by merely setting the light receiving element array 33 to be opposed to the reflecting face 21 and attaching the flexible substrate 34 to the triangular prism 13 and the base 23.

### Embodiment 4

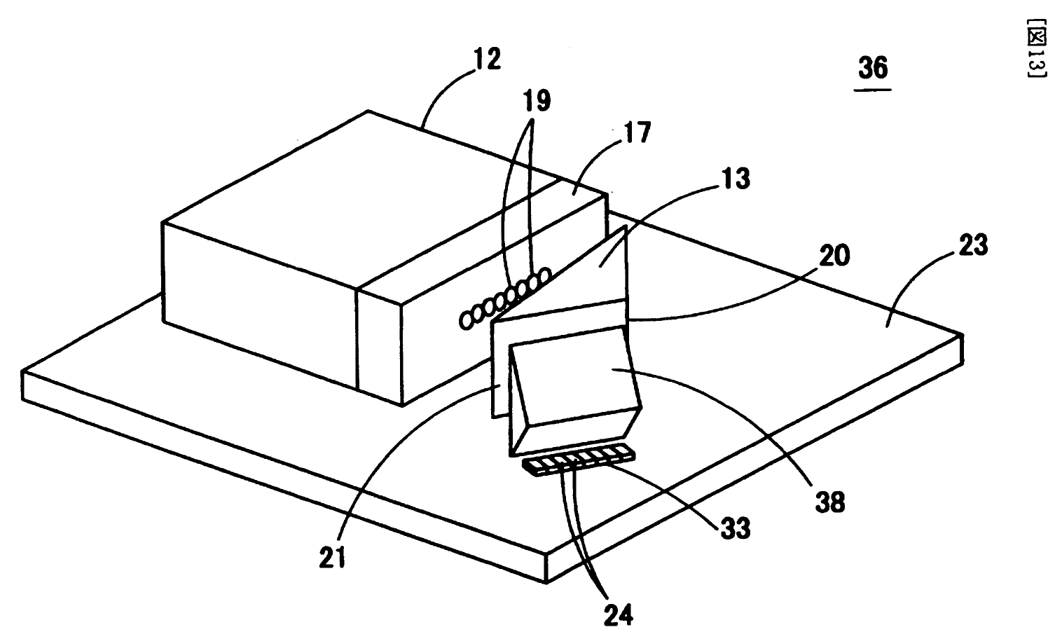

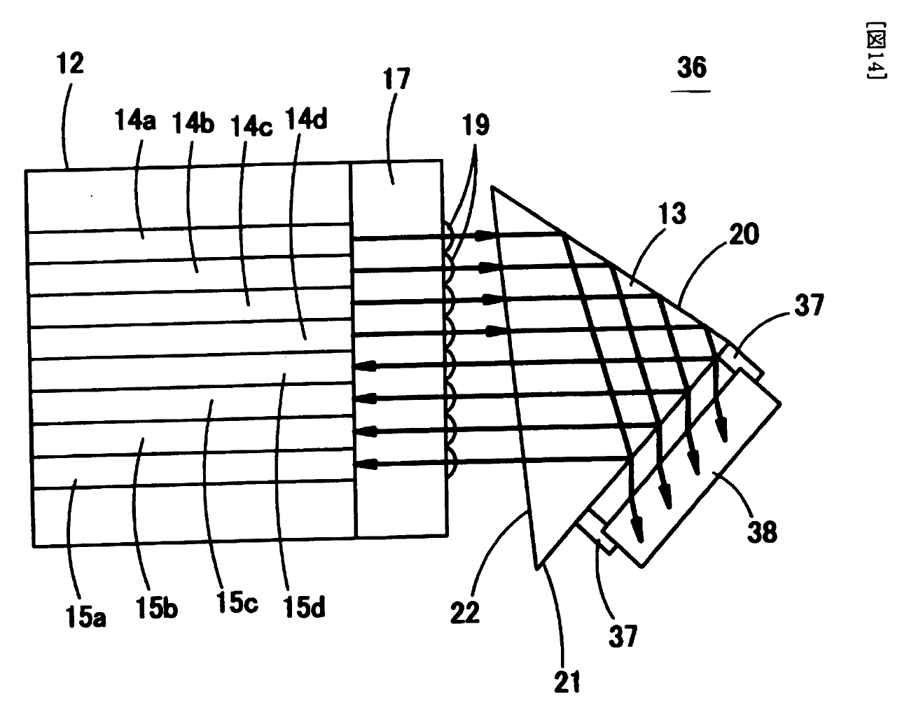

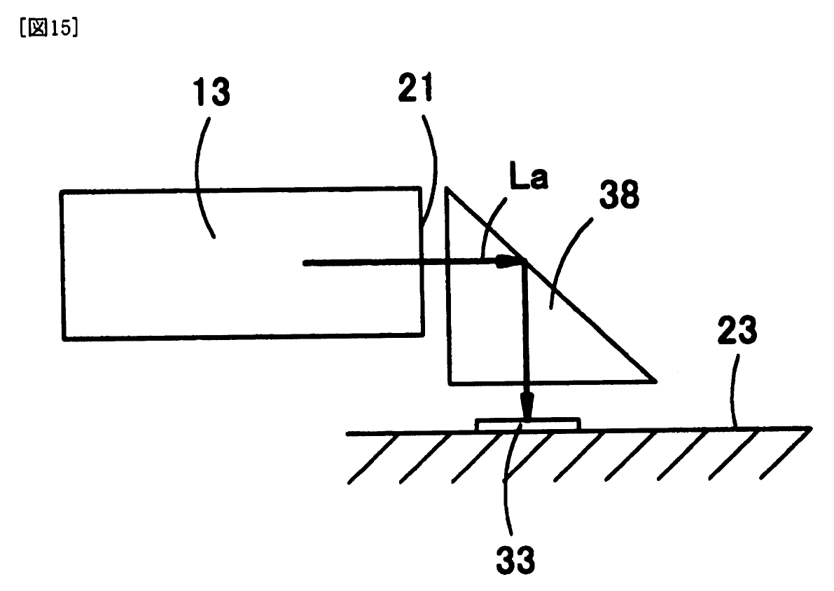

FIG. 13 is a perspective view showing the structure of a monitoring device 36 in an embodiment 4 of the present invention. FIG. 14 is a cross-sectional view of this structure. FIG. 15 is a schematic sectional view of the triangular prism 13 and a deflecting prism 38. In this monitoring device 36, the monitoring device 31 of the embodiment 2 is set to a foundation, and the deflecting prism 38 and the light receiving element array 33 are added to this monitoring device 31.

In this monitoring device 36, a deflecting prism 38 of a right-angled equilateral triangular shape in section is attached to the outside of the reflecting face 21 in advance through a spacer 37. The deflecting prism 38 is spaced from the reflecting face 21 with a clearance and is opposed to the reflecting face 21 in parallel. As shown in FIG. 15, leak light La leaked from the reflecting face 21 of the triangular prism 13 is bent by this deflecting prism 38 toward just below. A light receiving element array 33 is fixed to the upper face of the base 23 so as to receive each leak light La bent downward in the deflecting prism 38.

In accordance with this monitoring device 36, wiring with respect to the light receiving element array 33, etc. are facilitated since the light receiving element array 33 can be arranged in parallel with the base 23 on the base 23.

### Embodiment 5

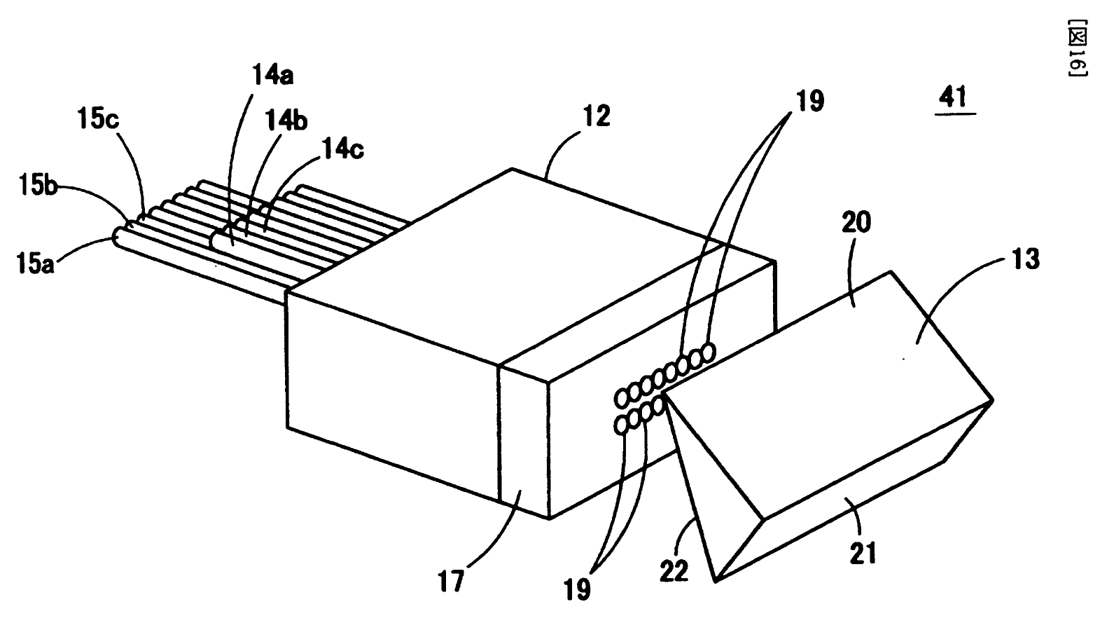

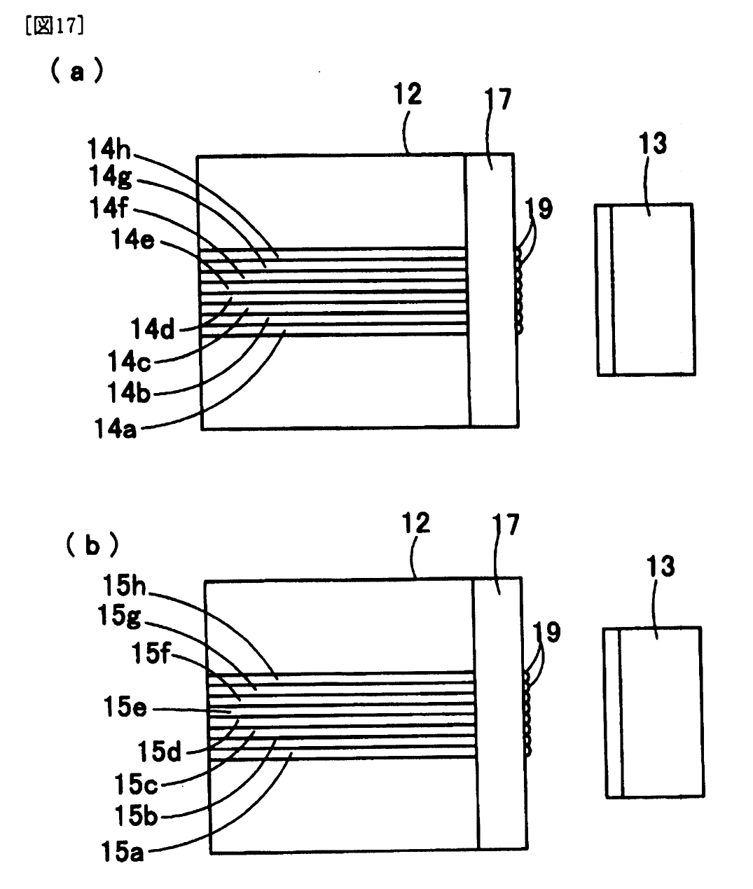

FIG. 16 is a perspective view showing the structure of a monitoring device 41 in an embodiment 5 of the present invention. In this monitoring device 41, an optical fiber array 12 having optical fibers 14a, 14b, - - - and optical fibers 15a, 15b, - - - of two stages is used. For example, in the optical fiber array 12, as shown in FIG. 17(a), plural optical fibers 14a, 14b, - - - are held in a line by properly arranging their end portions in parallel. Further, as shown in FIG. 17(b), plural optical fibers 15a, 15b, - - - are held in a line by properly arranging their end portions in parallel. The optical fibers 14a, 14b, - - - of the upper stage and the optical fibers 15a, 15b, - - - of the lower stage are vertically set to one-to-one correspondence. In the lens array 17, plural lenses 19 are also arranged at two stages correspondingly to the respective optical fibers 14a, 14b, - - - , 15a, 15b, - - - .

The triangular prism 13 is arranged such that the reflecting face 20 and the reflecting face 21 are vertically located and the incident-emitting face 22 is opposed to the lens 19. The triangular prism 13 is rotatably supported around a horizontal rotating axis (a support means is omitted).

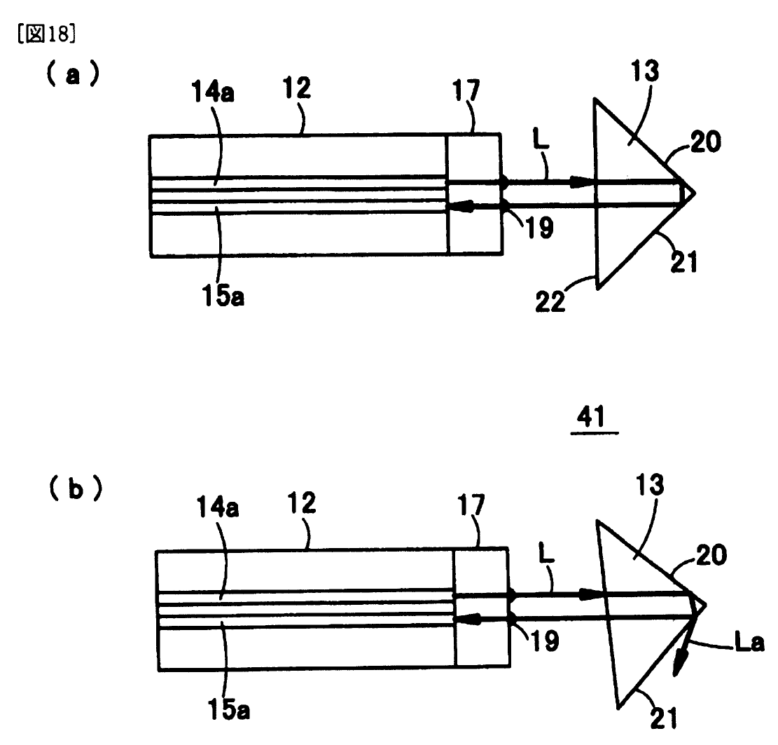

In a state before an adjustment, as shown in FIG. 18(a), the triangular prism 13 is arranged such that the incident-emitting face 22 and the lens array 17 are parallel. In this state, signal light L emitted from the optical fiber 14a is collimated by the lens 19, and is incident into the triangular prism 13. The signal light L is then twice totally reflected on reflecting faces 20, 21, and is incident to the lens 19 from the triangular prism 13. The signal light L is then converged by the lens 19 and is coupled to the optical fiber 15a. Similarly, signal lights L emitted from optical fibers 14b, 14c, - - - in parallel with each other respectively pass through the lens 19, and are twice totally reflected on the reflecting faces 20, 21 of the triangular prism 13. The signal lights L are then returned to the lens 19 and are respectively coupled to optical fibers 15b, 15c, - - - .

When the angle of the triangular prism 13, etc. are adjusted by a start from this state before the adjustment (adjusting methods in the horizontal direction and the vertical direction are different, but can be executed similarly to the method shown in FIG. 7), the signal light L emitted from each of the optical fibers 14a, 14b, 14c, - - - is incident to the reflecting face 21 at an equal incident angle as shown in FIG. 18(b). Accordingly, each signal light L is leaked out of the reflecting face 21 in an equal ratio κ. Hence, if the amount of the leak light La from the reflecting face 21 among the signal light L emitted from each of the optical fibers 14a, 14b, 14c, - - - is individually measured by a light receiving element, it is possible to monitor each amount of the signal light L propagated within each of the optical fibers 14a, 14b, 14c, - - - .

### Embodiment 6

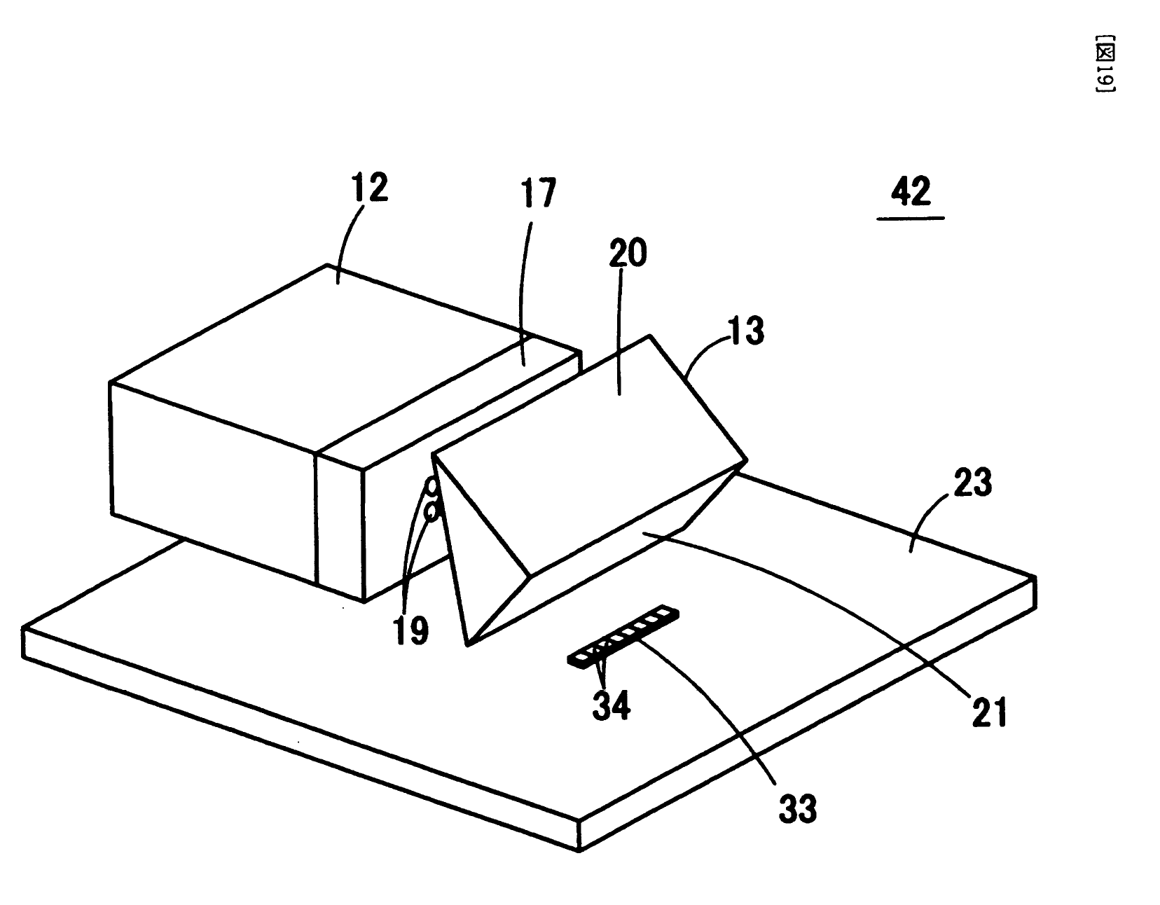

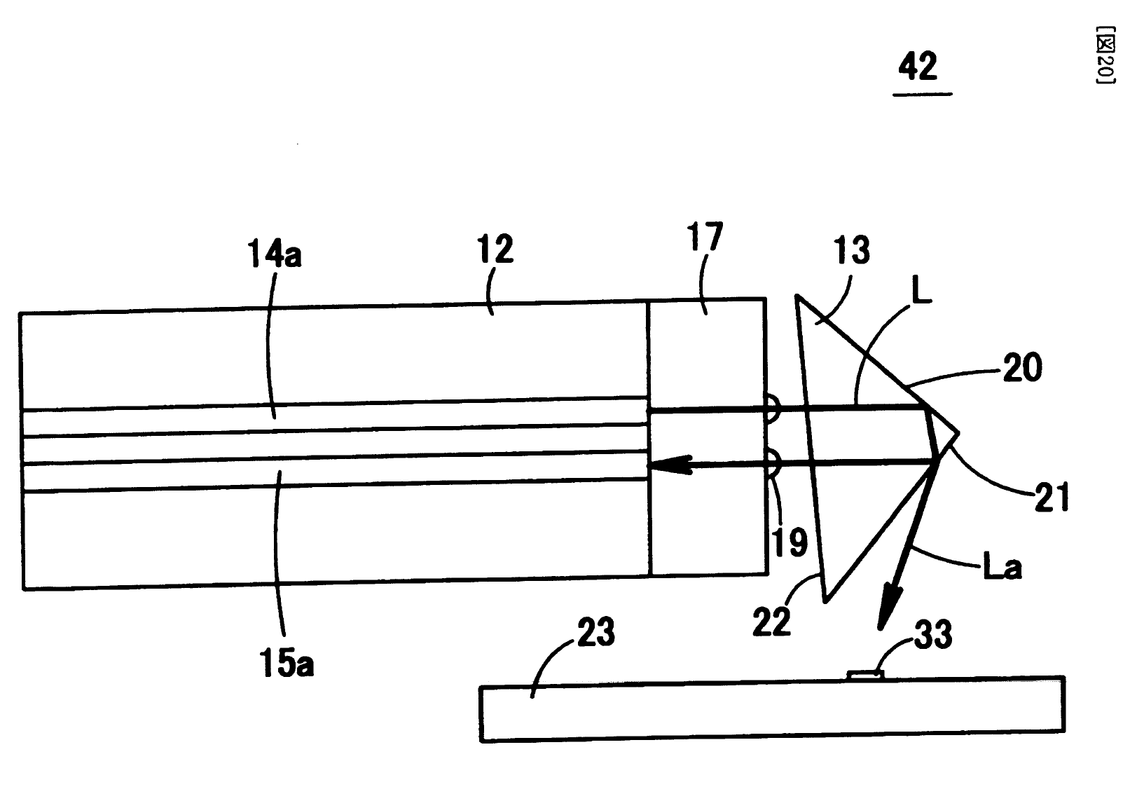

FIG. 19 is a perspective view showing the structure of a monitoring device 42 in an embodiment 6 of the present invention. FIG. 20 is an enlarged sectional view of this structure. In this monitoring device 42, the monitoring device 41 of the embodiment 5 is set to a foundation, and a light receiving element array 33, etc. are added to this monitoring device 41.

In this monitoring device 42, as shown in FIG. 20, the light receiving element array 33 is fixed to the upper face of the base 23 so as to receive each leak light La leaked from the triangular prism 13.

In accordance with this monitoring device 42, it is sufficient to mount the light receiving element array 33 onto the base 23. Accordingly, the light receiving element array 33 is very simply mounted.

### Embodiment 7

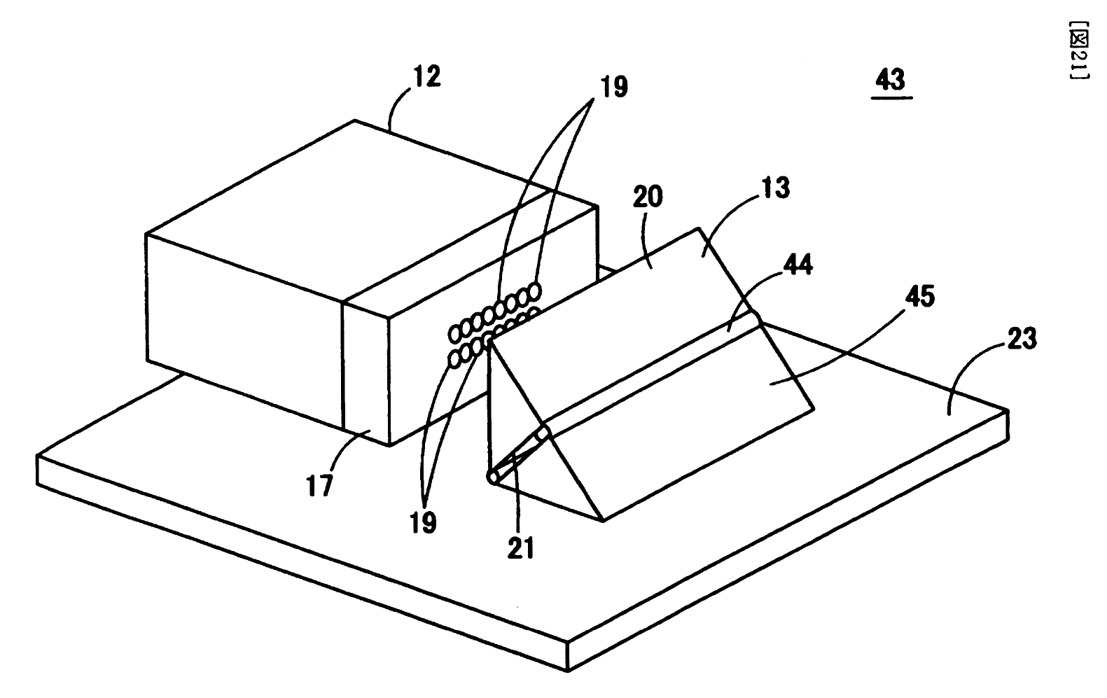

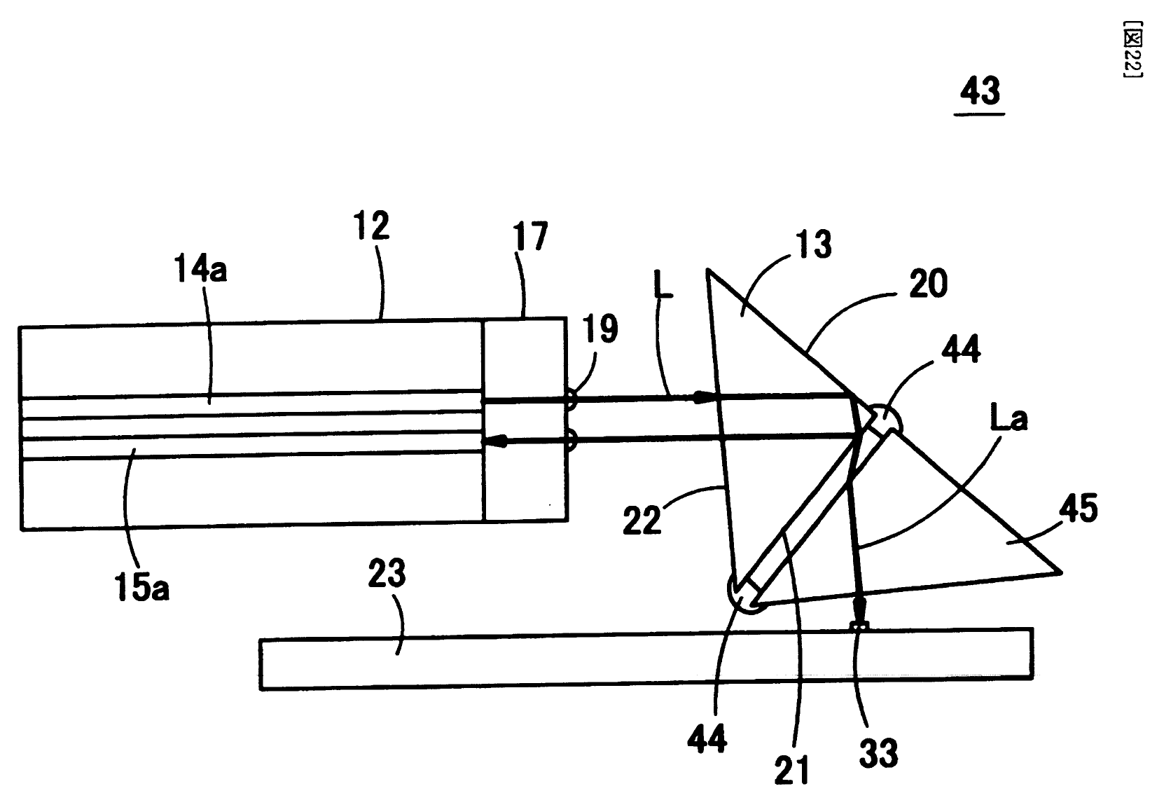

FIG. 21 is a perspective view showing the structure of a monitoring device 43 in an embodiment 7 of the present invention. FIG. 22 is an enlarged sectional view of this structure. In this monitoring device 43, the monitoring device 41 of the embodiment 5 is set to a foundation, and a light receiving element array 33, etc. are added to this monitoring device 41.

In this monitoring device 43, a deflecting prism 45 formed in the shape of a triangular prism is attached to the reflecting face 21 of the triangular prism 13 through a spacer 44. Leak light La emitted from the reflecting face 21 of the triangular prism 13 can be bent in a direction close to perpendicularity to the base 23 by attaching the deflecting prism 45 to the reflecting face 21. Accordingly, when the light receiving element array 33 is mounted so as to set the light receiving face of a light receiving element 24 to be parallel with the base 23, each light receiving element 24 can receive the leak light La approximately perpendicularly so that light receiving sensitivity is improved.

### Embodiment 8

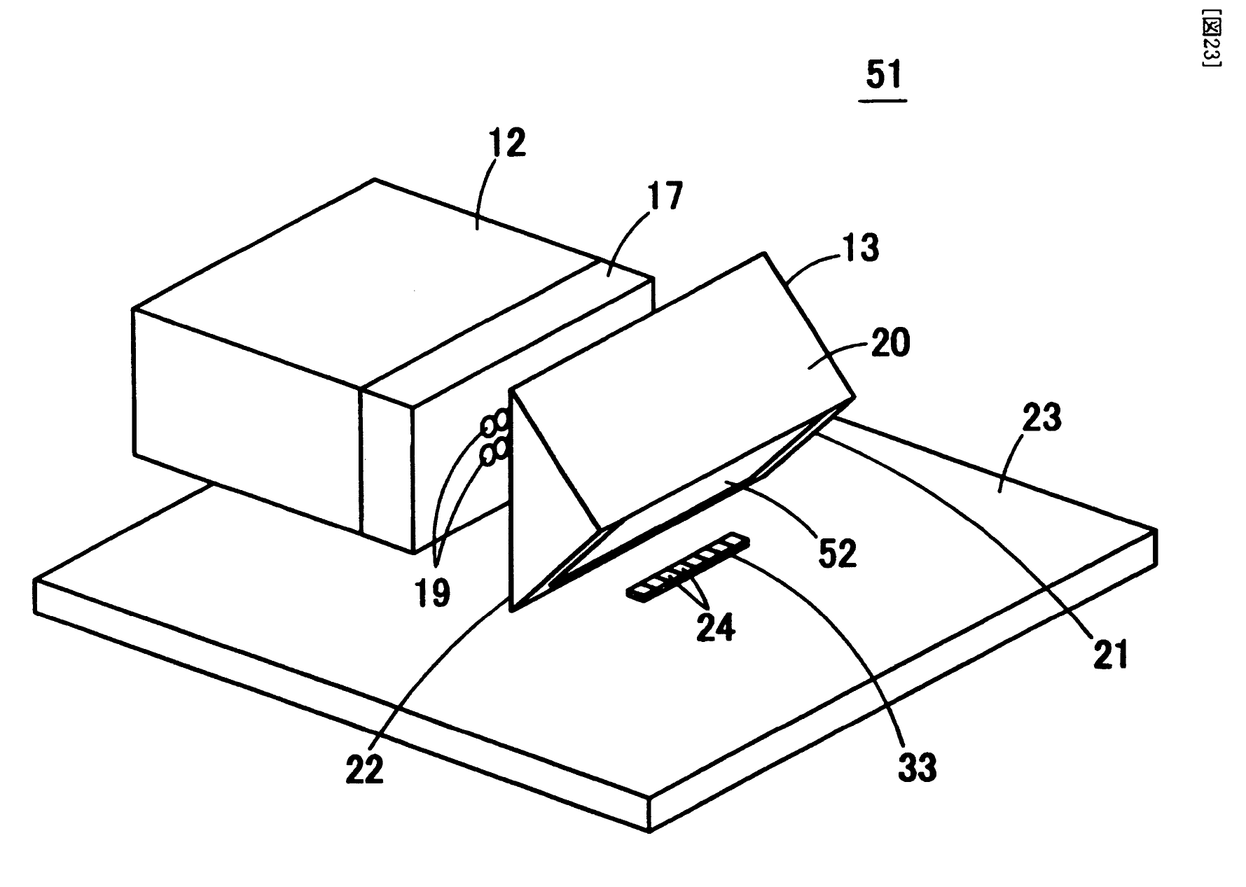

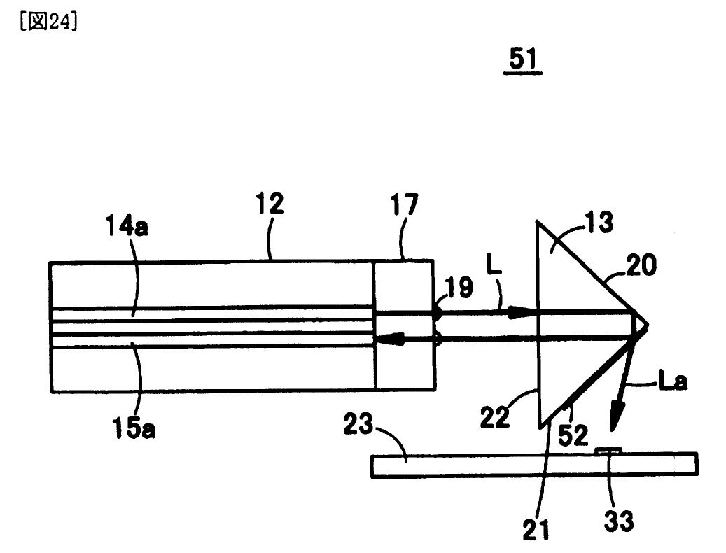

FIG. 23 is a perspective view of a monitoring device 51 in an embodiment 8 of the present invention. FIG. 24 is an enlarged sectional view of this monitoring device 51. In this monitoring device 51, leak light La is generated without changing the angle of the triangular prism 13.

The optical fiber array 12 explained in the embodiment 5 (FIG. 16) is used in this monitoring device 51. The triangular prism 13 is arranged such that the incident-emitting face 22 becomes parallel with the lens array 17. Further, a branch filter 52 is formed in at least an incident area of signal light L among the reflecting face 21 of the triangular prism 13. The branch filter 52 transmits light of a constant ratio K among the incident light, and reflects the remaining light. Further, a light receiving element array 33 is arranged in a reaching position of light transmitted through the branch filter 52.

In accordance with this monitoring device 51, as shown in FIG. 24, the signal light L emitted from an optical fiber 14a is converted into parallel light by the lens 19, and is then incident into the triangular prism 13. The signal light L is further totally reflected on the reflecting face 20 and is incident to the reflecting face 21. Since the branch filter 52 is stuck to the reflecting face 21, only the light amount κPo of a constant ratio among the light amount Po of the incident signal light L is transmitted through the branch filter 52 and is received by the light receiving element 24 of the light receiving element array 33. Accordingly, the original light amount Po=Pmoni/κ can be calculated by detecting the received light amount Pmoni of the light receiving element 24.

### Embodiment 9

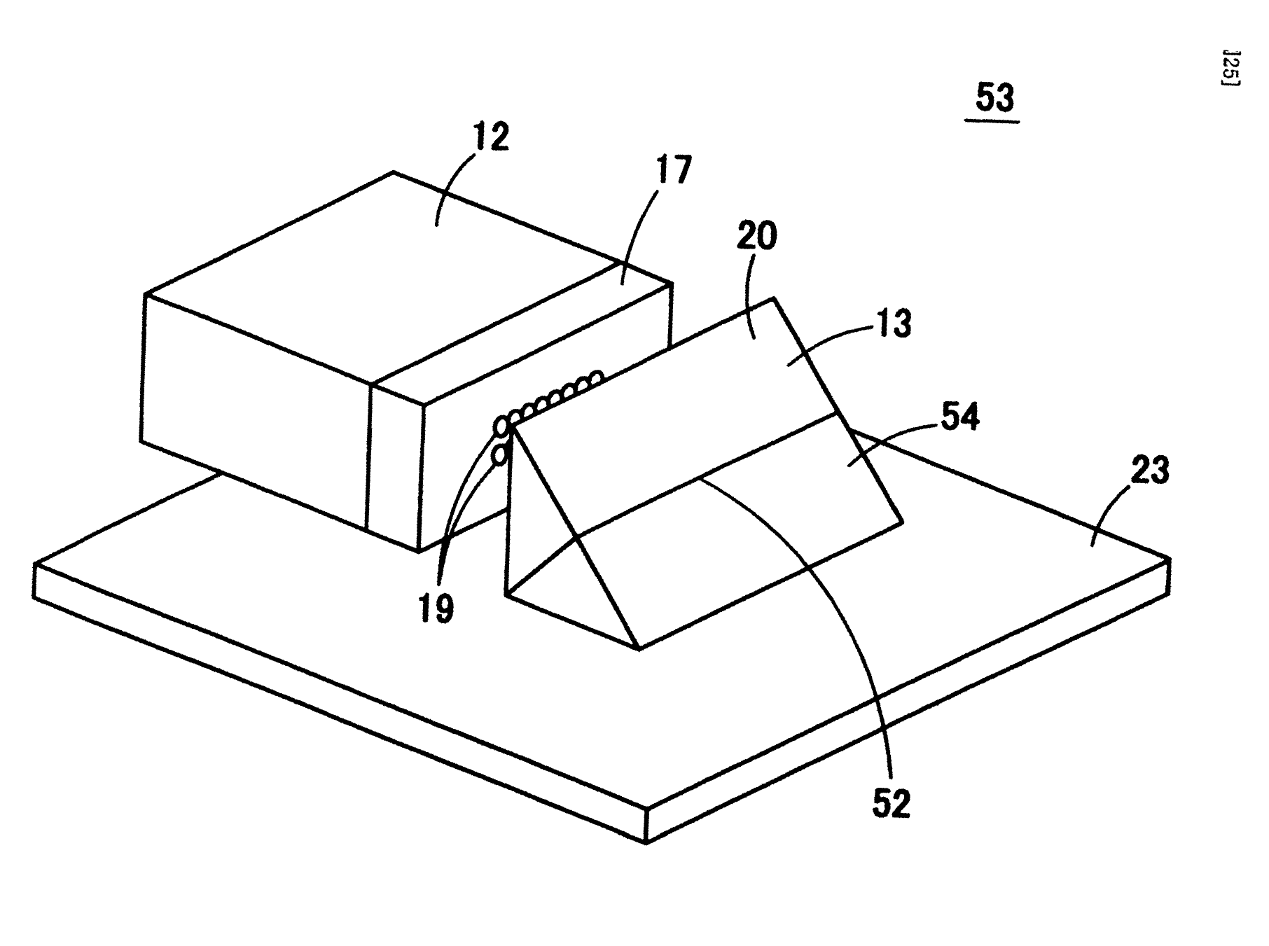

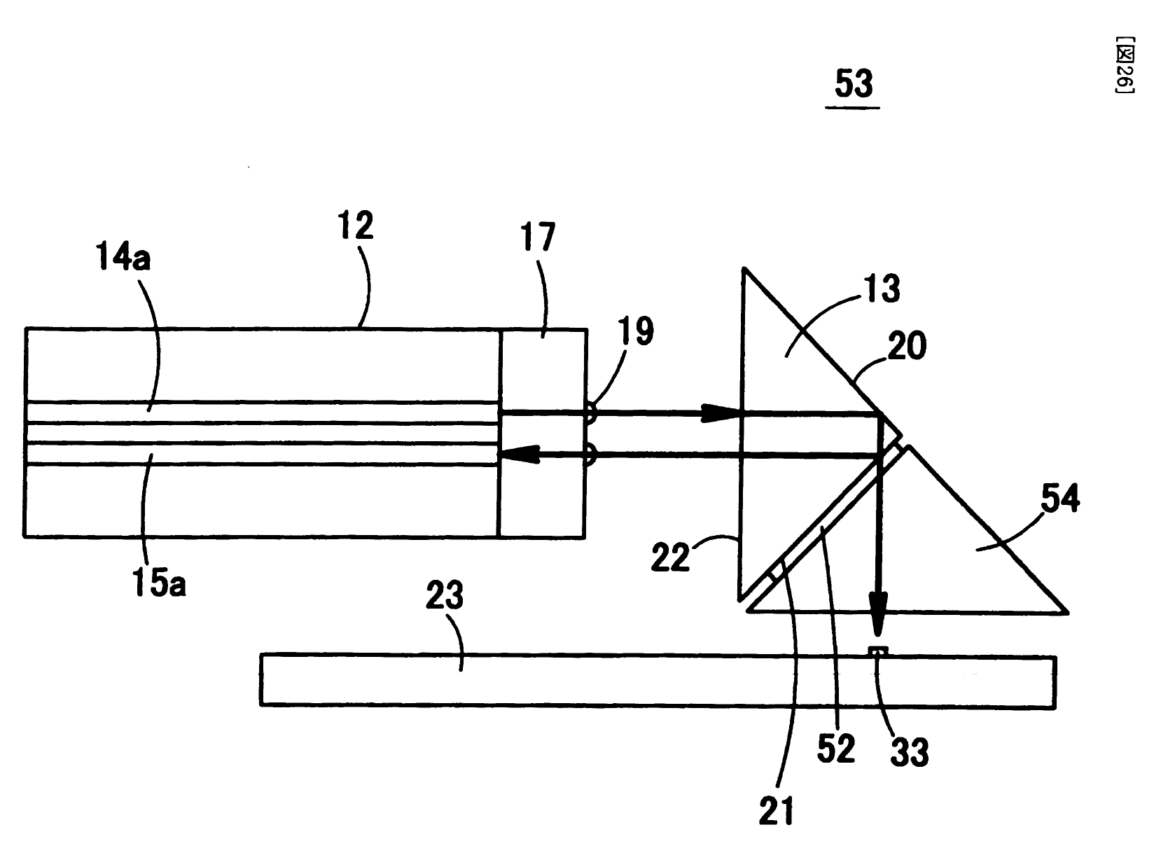

FIG. 25 is a perspective view of a monitoring device 53 in an embodiment 9 of the present invention. FIG. 26 is an enlarged sectional view of this monitoring device 53. In this monitoring device 53, a deflecting prism 54 formed in a triangular prism shape is added to the monitoring device 51 of FIG. 23. Namely, the deflecting prism 54 is attached to the reflecting face 21 of the triangular prism 13 through a branch filter 52 stuck to the reflecting face 21.

In accordance with this monitoring device 53, the direction of leak light La leaked by transmitting this leak light La through the branch filter 52 is bent by the deflecting prism 54. The leak light La can be then approximately perpendicularly incident to the light receiving element array 33 mounted to the base 23. Accordingly, sensitivity of the light receiving element 24 can be preferably set.

### INDUSTRIAL APPLICABILITY

The monitoring device of the present invention can be used in a use for monitoring the amount of signal light propagated in a light transmitting path of an optical fiber, an optical waveguide, etc. in the field of optical communication.

1. A monitoring device for detecting the amount of signal light propagated in a light transmitting path, and comprising:
said light transmitting paths in which at least end portions are held approximately in parallel and two light transmitting paths are set to one set; and
a prism having two interfaces perpendicular to each other, and returning the incident signal light toward an original incident direction by twice reflecting the signal light at the two interfaces;
wherein the signal light emitted from the end face of one light transmitting path among said one set of optical transmitting paths is incident into said prism; the signal light is returned to the original incident direction by twice reflecting the signal light at the two interfaces of the prism; the signal light is incident to the end face of the other light transmitting path among said one set of light transmitting paths; and the signal light of a predetermined ratio is leaked from at least one of the two interfaces of said prism.

2. The monitoring device according to claim 1, wherein light receiving means for receiving the signal light leaked from said interface is arranged.

3. The monitoring device according to claim 2, wherein said light receiving means is positioned with the leaking-out interface of the signal light in said prism as a reference.

4. The monitoring device according to claim 1, wherein, when it is seen from a direction perpendicular to a plane orthogonal with respect to the mutually orthogonal two interfaces of said prism, a line segment for dividing a narrow angle of said orthogonal two interfaces into two equal parts is inclined from a direction parallel with an optical axis direction of the end portion of said light transmitting path.

5. The monitoring device according to claim 1, wherein a filter for leaking-out one portion of the incident light to the exterior of a light transmitting property medium is formed at least one interface among the two interfaces of said prism.

6. The monitoring device according to claim 1, wherein deflecting means for changing an emitting direction of the signal light leaked from the interface of said prism is arranged.

7. The monitoring device according to claim 1, wherein plural sets of light transmitting paths are arranged with two light transmitting paths as one set, and these light transmitting paths are arranged in a line in parallel with a plane orthogonal with respect to the mutually orthogonal two interfaces of said prism.

8. The monitoring device according to claim 1, wherein plural sets of light transmitting paths are arranged with two light transmitting paths as one set, and the two light transmitting paths as one set are respectively arranged in parallel with a plane orthogonal with respect to the mutually orthogonal two interfaces of said prism.
